(19) United States
(12) Patent Application Publication
(10) Pub. No.: US 2009/0216864 A1
(43) Pub. Date: Aug. 27, 2009

(54) METHODS, APPARATUSES, AND COMPUTER PROGRAM PRODUCTS, FOR AUTOMATICALLY FINDING CONFIGURATION SETTINGS FOR SERVICES

(75) Inventor: Jaripekka Salminen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/038,460

(22) Filed: Feb. 27, 2008

(51) Int. Cl. G06F 15/177

(52) U.S. Cl. 709/220

(57) ABSTRACT

An apparatus may include a processor configured to receive an indication of a service and determine whether configuration settings for the indicated service are previously stored. The processor may be further configured to retrieve stored configuration settings for the indicated service if configuration settings for the indicated service are previously stored and to receive suggested configuration settings for the indicated service if configuration settings for the indicated service are not previously stored. The processor may additionally be configured to verify the stored or suggested configuration settings and to store the verified configuration settings in association with the indicated service. Corresponding methods and computer program products are also provided.

### TECHNOLOGICAL FIELD

Embodiments of the present invention relate generally to mobile communication technology and, more particularly, relate to methods, apparatuses, and computer program products for automatically finding configuration settings for mobile device services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the ease of information transfer and convenience to users involves the configuration of mobile terminal services. Some of these services have been commonly available for users of personal computers and other computing devices for some time, but recently have become available to mobile terminal users due to the growth in wireless and mobile networking technologies as well as continued development of processing power and miniaturization of high-powered processors and components used in mobile computing devices. Examples of these services include e-mail, instant messaging, multi-player gaming, peer-to-peer file transfer, and web browsing.

These services may require mobile terminal users to configure multiple configuration settings to enable the functionality of services. For example, a user may have to configure one or more server names, server type settings, port settings, and security settings to enable the functionality of services. The appropriate settings for these configuration settings may vary with the type of service, the user's device type, the service provider's network, the user's location, and other factors. As such, users who are less technologically savvy may have a hard time configuring settings for services. Indeed, it may be frustrating and time consuming for a user to determine appropriate configuration settings or otherwise experiment with configuration settings for a service until finding a set of working configuration settings. The intimidation and inherent frustration that many users may experience in configuring services may cause users to forego the configuration of some services and thus may limit the utilization of services that may otherwise be of great use to users.

Accordingly, it may be advantageous to provide users with a system for automatically finding and providing configuration settings which have been verified to work previously for other users of a service. Such a system may thereby address at least some of the disadvantages described above.

### BRIEF SUMMARY

A method, apparatus, and computer program product are therefore provided to enable automatically finding configuration settings for services and subsequently providing those configuration settings to user devices. In particular, a method, apparatus, computer program product, and system are provided to enable, for example, a user of a device to indicate to a remote computing device a service which the user wishes to implement on the user device. The remote computing device may then determine configuration settings for the service which have been previously verified and submit those to the user device. Accordingly, user experience may be enhanced by enabling users with limited technical knowledge and experience to quickly configure services on their devices.

In one exemplary embodiment, a method is provided which may include receiving an indication of a service and in response to receiving the indication determining whether configuration settings for the indicated service are previously stored. The method may further include retrieving stored configuration settings for the indicated service if configuration settings for the indicated service are previously stored and receiving suggested configuration settings for the indicated service if configuration settings for the indicated service are not previously stored. The method may further include verifying the stored or suggested configuration settings and storing verified configuration settings in association with the indicated service.

In another exemplary embodiment, a computer program product is provided. The computer program product includes at least one computer-readable storage medium having computer-readable program code portions stored therein. The computer-readable program code portions include first, second, third, fourth, fifth, and sixth executable portions. The first executable portion is for receiving an indication of a service. The second executable portion is for determining whether configuration settings for the indicated service are previously stored. The third executable portion is for retrieving stored configuration settings for the indicated service if configuration settings for the indicated service are previously stored. The fourth executable portion is for receiving suggested configuration settings for the indicated service if configuration settings for the indicated service are not previously stored. The fifth executable portion is for verifying the stored or suggested configuration settings. The sixth executable portion is for storing verified configuration settings in association with the indicated service.

In another exemplary embodiment, an apparatus is provided, which may include a processor. The processor may be configured to receive an indication of a service and in response to receiving the indication determine whether configuration settings for the indicated service are previously stored. The processor may be further configured to retrieve stored configuration settings for the indicated service if configuration settings for the indicated service are previously stored or receive suggested configuration settings for the indicated service if configuration settings for the indicated service are not previously stored. The processor may further be configured to verify the stored or suggested configuration settings and store verified configuration settings in association with the indicated service.

In another exemplary embodiment, an apparatus is provided. The apparatus may include means for receiving an indication of a service and in response to receiving the indication means for determining whether configuration settings for the indicated service are previously stored. The apparatus may further include means for retrieving stored configuration settings for the indicated service if configuration settings for the indicated service are previously stored and means for receiving suggested configuration settings for the indicated service if configuration settings for the indicated service are not previously stored. The apparatus may additionally include means for verifying the stored or suggested configuration settings and means for storing verified configuration settings in association with the indicated service.

Embodiments of the invention may therefore provide a method, apparatus, and computer program product to enhance user experience related to the configuration and use of services. As a result, for example, users may benefit from using mobile terminals and other electronic devices with improved ability to configure settings required for the use of services.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for automatically finding configuration settings for services;

FIG. 4 illustrates a sequence of screen captures provided by a user interface of a user device implementing embodiments of the invention;

FIG. 5 is a flow diagram according to an exemplary method for automatically finding configuration settings for an e-mail account according to an exemplary embodiment of the present invention;

FIG. 6 is a flow diagram according to an exemplary method for automatically finding configuration settings for an e-mail account according to an exemplary embodiment of the present invention; and

FIG. 7 is a flowchart according to an exemplary method for automatically finding configuration settings for a service according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

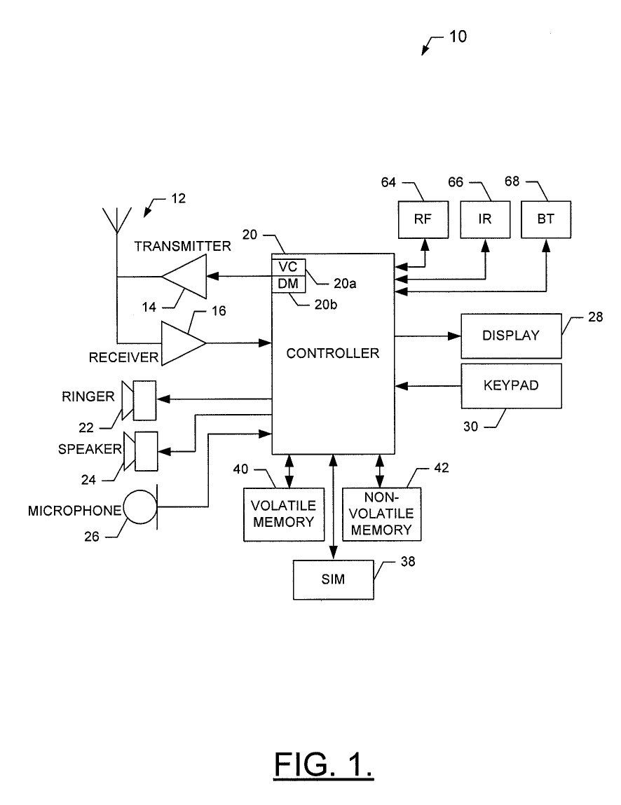

FIG. 1 illustrates a block diagram of a mobile terminal 10 that may benefit from the present invention. It should be understood, however, that the mobile terminal illustrated and hereinafter described is merely illustrative of one type of electronic device that may benefit from embodiments of the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ embodiments of the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as a UMTS network employing WCDMA radio access technology. Some NAMPS, as well as TACS, mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

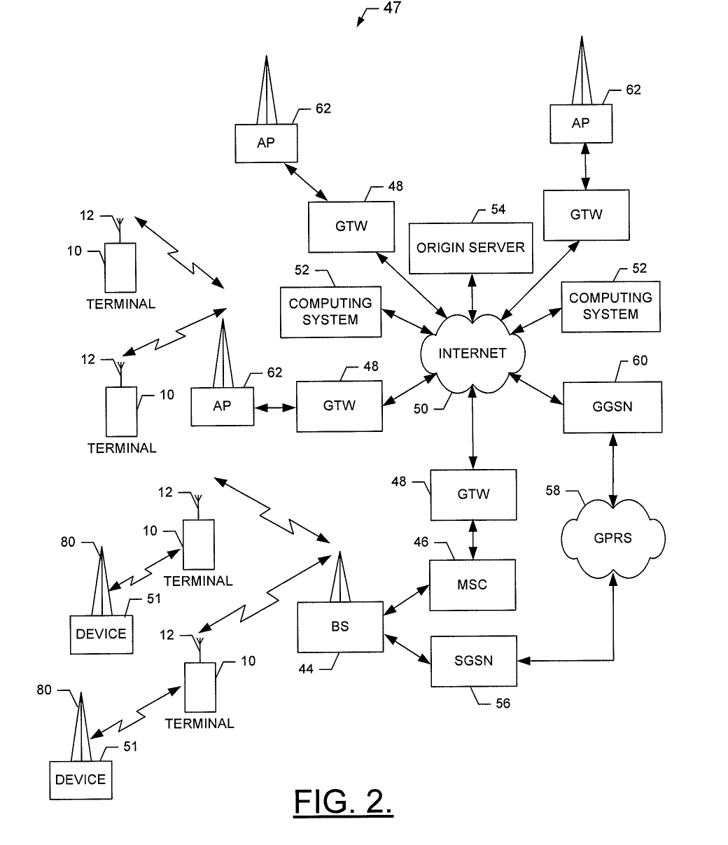

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 12 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 may comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

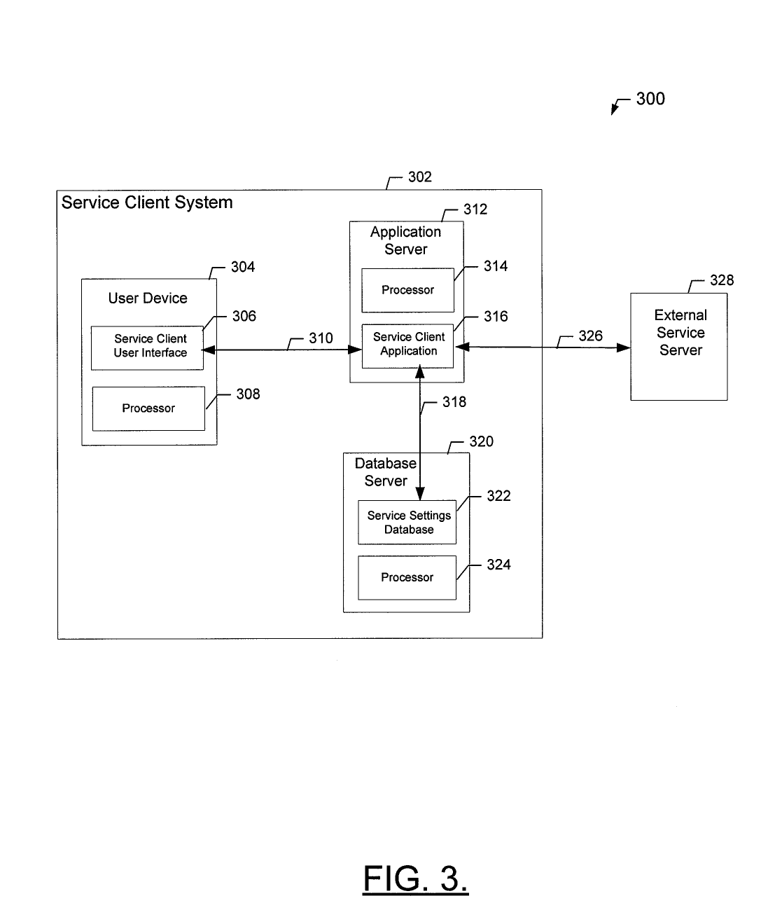

FIG. 3 illustrates a block diagram of a system 300 for automatically finding configuration settings for services according to an exemplary embodiment of the present invention. As used herein, “exemplary” merely means an example and as such represents one example embodiment for the invention and should not be construed to narrow the scope or spirit of the invention in anyway. It will be appreciated that the scope of the invention encompasses many potential embodiments in addition to those illustrated and described herein. The system 300 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for automatically finding configuration settings for services, numerous other configurations may also be used to implement embodiments of the present invention.

Referring now to FIG. 3, the system 300 may include a service client system 302 and an external service server 328. Although referred to herein as a “server,” the external service server 328 may be embodied as any computing device or plurality of computing devices configured to provide a service. The service client system 302 may include a user device 304, an application server 312, and a database server 320. A “service” may be any software or hardware implemented functionality that may be implemented on a computing device, such as for example, a user device 304, which may require communication with a remote device which provides or otherwise enables the service, such as the external service server 328. Examples of such services may include, for example, e-mail; instant messaging; multi-player gaming; peer-to-peer file transfer; and web browsing, such as when using a proxy server. As such, the external service server 328 may provide data or otherwise facilitate communication for such services to a plurality of users of remote computing devices, such as the user device 304, of the service client system 302. In this regard, the external service server 328 may be, for example, an e-mail server, gaming server, a node in a peer-to-peer network facilitating file transfer, or a proxy server.

These services may require a user of a user device 304 to configure a variety of configuration settings to enable use of the service. These configuration settings may define, for example, how the user device 304 is to communicate with the external service server 328 so as to provide the user device 304 with access to the service. Configuration settings may include, for example, server name, server type (such as IMAP, POP3, etc for e-mail servers), server ports, security settings (e.g. SSL, normal), and outgoing server name. As such, configuration settings may define not only the remote computing device with which the user device 304 should communicate when using a service, but also how to communicate with the remote computing device. It will be appreciated then that proper configuration settings for a user of a service may vary, for example, with the type of user device 304 the user is using, the user's location, the user's provider network, how the user is using the service, as well as many other factors.

The service client system 302 may facilitate automatically finding settings for services as well as providing for the end-user interface on the user device 304. The user device 304 may be a mobile device, such as a mobile terminal 10. However, it will be appreciated that the present invention is not so limited in scope and users of any computing device may benefit from embodiments of the present invention. As such, the user device 304 may be any computing device using a service, such as for example, a desktop personal computer. The user device 304 may include a service client user interface 306 and a processor 308. The processor 308 may, for example, be the controller 20 of a mobile terminal 10. The service client user interface 306 may be embodied in hardware or software and may be embodied as or otherwise controlled by the processor 308. In some embodiments, the service client interface 306 may be a WIDSETS component.

The service client user interface 306 may simply be configured to provide user interface functionality for a service, such as providing for the display of data relating to the service as well as facilitating user interaction with the service. In this regard, the service itself or at least portions thereof may be implemented and executed by another component of the user device 304 or by a remote device, such as by the service client application 316 of the applications server 312 or by the external service server 328. Alternatively, the service client user interface 306 may fully provide for all functionalities necessary to execute the service on the user device 304 and may communicate with the service client application 316 or external service server 328 only for purposes of data transmission or other communications. Additionally the user device 304 may have a plurality of service client user interfaces 306, such as one for each service implemented by the user device 304, or may have one single service client user interface 306 configured to provide a user interface for all services implemented on the user device 304.

The service client user interface 306 may be in communication with the application server 312, such as with the service client application 316 of the application server 312 via communication link 310. The application server 312 may be any computing device or plurality of computing devices configured to receive an indication of a service, such as from the service client user interface 306 of a user device 304, determine whether configuration settings for the service are previously stored, and to communicate configuration settings to and receive configuration settings from the service client user interface 306 of a user device 304. As such, the application server 312 may include a processor 314 and a service client application 316. The processor 314 may be a single processor or may comprise multiple processors executed in parallel, which may be contained in a single computing device or may be distributed between multiple computing devices, such as in a server cluster.

The service client application 316 may be embodied in hardware or software and may be embodied as or otherwise controlled by the processor 314. In this regard, the service client application 316 may simply be configured to communicate configuration settings for one or more services to and from user devices 304. Additionally or alternatively, in some embodiments, a service may be distributed between the service client user interface 306 of a user device 304 and the service client application 316. In this regard, some or all of the non-user interface functionality of a service may be implemented by the service client application 316. The service client application 316 may further be configured to communicate with the external service server 328 over the communication link 326. In this regard, the service client application 316 may be configured to connect to and communicate with the external service server 328 using configuration settings previously stored, such as in the service settings database 322 or received from the service client user interface 306 of the user device 304.

The service client application 316 may further be configured to communicate with the database server 320, such as with the service settings database 322 of the database server 320 over the communication link 318. The database server 320 may be any computing device or plurality of computing devices configured to store configuration settings for services and to communicate those configuration settings to the service client application 316. As such, the database server 320 may comprise a service settings database 322 and a processor 324. Although illustrated in FIG. 3 as two separate computing devices, in some embodiments the application server 312 and database server 320 may be embodied on a single computing device.

The service settings database 322 may be embodied on a memory and controlled by the processor 324 such that the service settings database is configured to store configuration settings for a plurality of services. In this regard, the service settings database 322 may store configuration settings for each user of each service of the system 300 in association with the service. Thus, for example, the service settings database 322 may store each set of configuration settings used by each user of a user device 304 of the system 300 for e-mail service provided by GMAIL in association with a unique identifier indicating that the stored configuration settings are for GMAIL e-mail service. In this regard, the service settings database may store every single set of configuration settings used by a user device 304 for a service, even if multiple sets are duplicative. Alternatively, in some embodiments the service settings database may only store unique sets of configuration settings for a service but may also store a numeric indication of the number of users of user devices 304 who have used that set of configuration settings in association with each unique set of configuration settings for a service.

In addition to storing configuration settings, the service settings database 322 may be configured to receive an indication of a service, such as from the service client application 316 over the communications link 318, and look up stored configuration settings for the service and communicate stored configuration settings for the service to the service client application 316. In that regard, the service settings database 322 may further be configured to determine which set of configuration settings is most frequently stored for a service, such as by using the value of the numeric indication in embodiments wherein the service settings database 322 stores a numeric indicator in association with each unique set of configuration settings for a service. In this regard, it will be appreciated that the set of configuration settings most frequently used previously for a service and hence stored most frequently may be the set of configuration settings most likely to work for new users of a service. This storing, look up, and communication of configuration settings as performed by the service settings database may be controlled by the processor 324. In this regard, the processor 324 may be a single processor or may comprise multiple processors executed in parallel, which may be contained in a single computing device or may be distributed between multiple computing devices, such as in a server cluster.

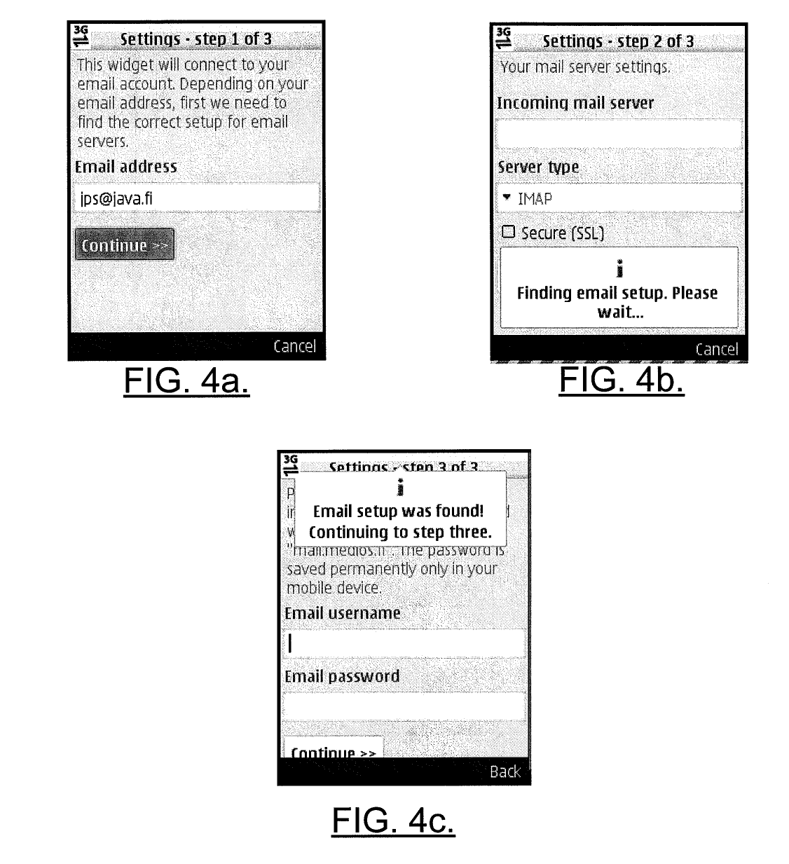

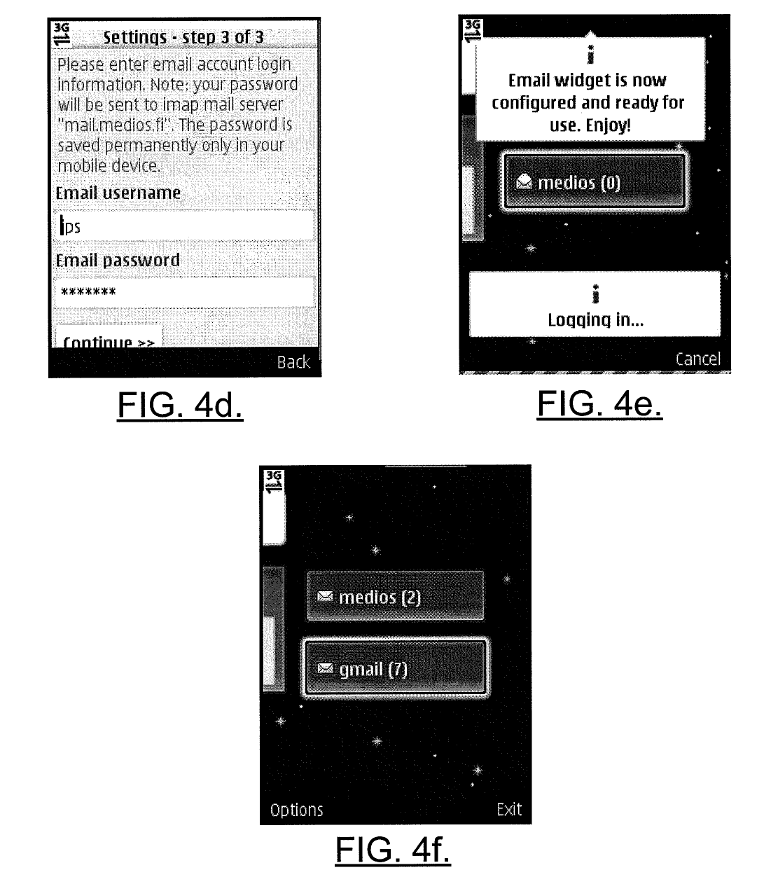

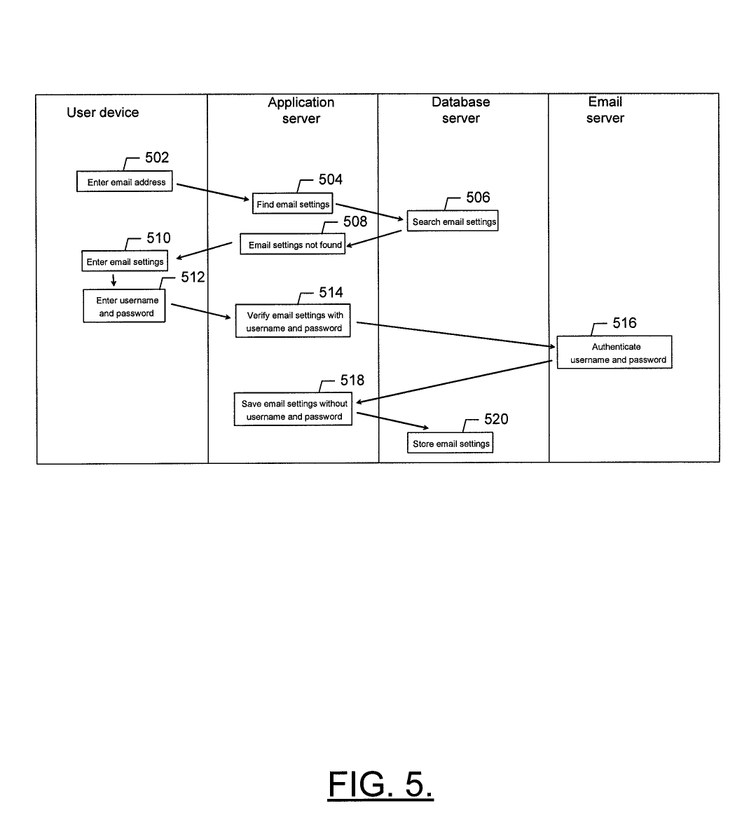

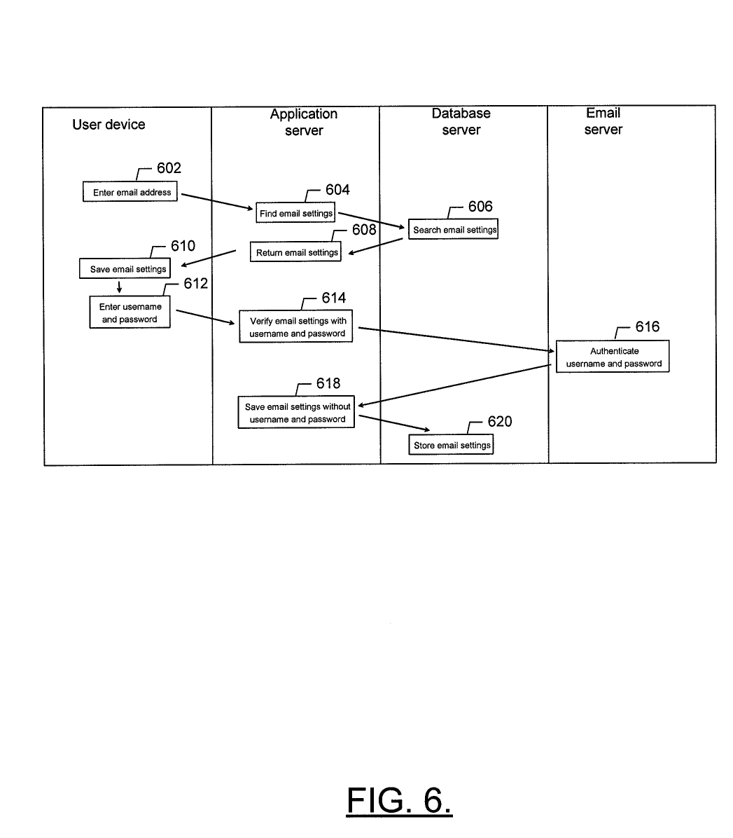

Referring now to FIGS. 4-6, the operation of the system 300 will be described in the context of an e-mail service. In this regard, FIGS. 4a-4f illustrate a series of screen captures of a user interface, which may be provided by the service client user interface 306 of a user device 304 for configuring the settings for a service. These screen captures may be displayed to a user on a display of the user device 304, such as on the display 28 of a mobile terminal 10. FIGS. 5 and 6 illustrate flow diagrams of communications between devices of the system 300 in the context of automatically finding configuration settings for an e-mail account first in a situation in which configuration settings for the e-mail account are not previously stored and second in a situation in which configuration settings for the e-mail account are previously stored, respectively.

As such, referring now to FIG. 5, a user desiring to set up an e-mail service on a user device 304 may enter an e-mail address into the service client user interface 306 at operation 502. An example is illustrated in the screen capture of FIG. 4a for which the user has entered the e-mail address “jps@java.fi.” The service client user interface 306 may then communicate the e-mail address as an indication of a service to the service client application 316 of the application server 312. In this example, the e-mail service indication may be “java.fi.” The service client application 316 may then attempt to find stored configuration settings at operation 504. An indication of the attempt to find configuration settings may then be displayed on the user device 304 as indicated in FIG. 4b. The service client application 316 may then send an indication of the service to the service settings database 322 such that the service settings database 322 may search for stored configuration settings for the e-mail service, i.e. “java.fi” at operation 506. If the user of the user device 304 is the first to attempt to configure the service on the system 300, then the service settings database 322 may not have access to any previously stored configuration settings for the service. As such, the service settings database 322 may indicate to the service client application 316 that e-mail setup configuration settings were not found, which indication may then be passed on to the service client user interface 306 at operation 508.

In such instances in which stored configuration settings for a service are not previously stored, the service client user interface 306 may then prompt the user to enter suggested service configuration settings, i.e., e-mail settings, at operation 5 10. The service client user interface 306 may further prompt for the user to enter one or more user settings unique to the user, such as a username and password at operation 512 and as illustrated in FIG. 4d. In this regard, user settings are settings which may be used by the external service server 328 or other service providing computing device to uniquely identify a user of the service, but which do not represent actual configuration settings enabling a service to be implemented and used on a user device 304. Thus, in the e-mail context, a user name may be the “jps” portion of the e-mail address “jps@java.fi” while “java.fi” identifies the e-mail service provider and represents a configuration setting. The user's suggested configuration settings and user settings may then be sent to the service client application 316, which may then verify the e-mail settings with the e-mail username and password at operation 514 by communicating the information to the external service server 328, which in this example may be an external e-mail server.

At operation 516, the external e-mail server may then authenticate the username and password, such as by logging the user of the user device 304 onto the e-mail server using the username and password. In this regard, the service client application 316's verification of the configuration settings may comprise attempting to log into the e-mail server, i.e., an external service server 328, and communicate with the external service server 328 using a protocol appropriate to the service, such as IMAP or POP3 protocol for e-mail services. Success in verifying the suggested configuration settings or any error conditions may be indicated to a user of the user device 304 by the service client user interface 306, such as in the screen capture of FIG. 4e. The user device 304 may locally store verified suggested configuration settings in memory, such as memory 42 of a mobile terminal 10. The service client application 316 may direct the service settings database 322 to store verified suggested configuration settings without the user settings, i.e., the username and password, at operation 518 and the service settings database may then store the verified e-mail configuration settings at operation 520.

Referring now to FIG. 6, a user desiring to set up an e-mail service on a user device 304 may enter an e-mail address into the service client user interface 306 at operation 602. An example is again illustrated in the screen capture of FIG. 4a, in which the user has entered the e-mail address “jps@java.fi.” The service client user interface 306 may then communicate the e-mail address as an indication of a service to the service client application 316 of the application server 312. At operation 604, the service client application 316 may attempt to find stored configuration settings. An indication of the attempt to find configuration settings may then be displayed on the user device 304 as indicated in FIG. 4b. The service client application 316 may then send an indication of the service to the service settings database 322 such that the service settings database 322 may search for stored configuration settings for the e-mail service, i.e. “java.fi” at operation 606. In the example flow of FIG. 6, configuration settings for this service have already previously been stored. As such, the service settings database 322 may send stored e-mail configuration settings to the service client application 316, which may then send them to the user device 304 at operation 608. In some embodiments, the configuration settings sent by the service settings database 322 may be the most frequently stored set of configuration settings for the service. The service client user interface 306 may provide indication for the user that e-mail setup configuration settings have been found as illustrated in FIG. 4c.

The user device may then save the e-mail configuration settings, at operation 610. It will be appreciated that the saving of the received configuration settings at operation 610 may be temporary, such as in volatile memory 40 of a mobile terminal 10 and that the user device 304 may not permanently store the configuration settings, such as in non-volatile memory 42 until the settings have been verified to work. The service client user interface 306 may further prompt for the user to enter one or more user settings unique to the user, such as a username and password at operation 612, which is illustrated in FIG. 4d. The user settings may then be sent to the service client application 316, which may then verify the e-mail settings with the e-mail username and password at operation 614 by communicating the information to the external e-mail server. In this regard, a user of a user device 304 may be provided with an indication of the retrieved stored configuration settings prior to verification. Referring again to the screen capture of FIG. 4d, the user may be informed that the password will be sent to “mail.medios.fi” so as to limit the possibility that a user's private user settings may be sent to the wrong service server, which may then provide the private user settings to third parties for illicit purposes.

At operation 616, the external e-mail server may then authenticate the username and password. Success in verifying the suggested configuration settings or any error conditions may be indicated to a user of the user device 304 by the service client user interface 306, such as in the screen capture of FIG. 4e. The service client application 316 may direct the service settings database 322 to store verified suggested configuration settings without the user settings, i.e. username and password, at operation 618. The service settings database may then store the verified e-mail configuration settings at operation 620.

It will be appreciated that a user device 304 may simultaneously implement and use multiple services, such as multiple e-mail addresses. An example is illustrated in the screenshot of FIG. 4f in which two e-mail services (GMAIL and MEDIOS) are concurrently running on the user device 304.

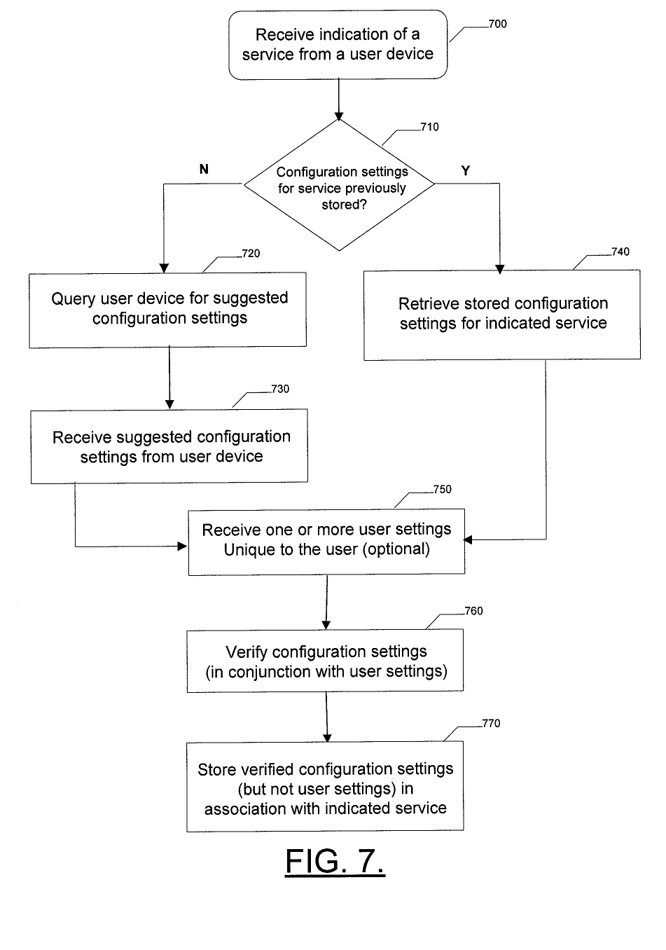

FIG. 7 is a flowchart of a system, method, and computer program product according to an exemplary embodiment of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowcharts, and combinations of blocks or steps in the flowchart, may be implemented by special purpose hardware-based computer systems which perform the specified functions or steps, or combinations of special purpose hardware and computer instructions.

In this regard, one embodiment of a method of automatically finding configuration settings for a service as illustrated in FIG. 7 may include receiving an indication of a service from a user device at operation 700. The service client application 316 and/or service settings database 322 may then determine whether configuration settings for the service are previously stored at operation 710. If configurations settings for the service are not previously stored, then the service client application 316 may query the user device for suggested configuration settings at operation 720. Operation 730 may then comprise receiving suggested configuration settings from the user device. If, on the other hand, at operation 710 it is determined that configuration settings for the service are previously stored, then operation 740 may comprise retrieving stored configuration settings for the indicated service. In embodiments wherein the service client application 316 is configured to retrieve the most frequently stored set of configuration settings for a service, operation 740 may further comprise determining and retrieving the most frequently stored set of configuration settings.

The service client application 316 may then optionally receive one or more user settings unique to the user, such as a user name and password for the service at operation 750. Operation 760 may then comprise the service client application 316 verifying either the retrieved stored configuration settings or the received suggested configuration settings in conjunction with any received user settings. Although not shown, if the stored or suggested configuration settings do not work and as such are not verified, the service client application 316 may further query the user device for an alternative set of suggested configuration settings. Operation 770 may then comprise storing verified configuration settings, but not user settings in association with the indicated service.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. For example, a user of a user device may wish to configure and enable a service on his user device. By providing the user of the user device with a system according to embodiments of the invention for automatically finding configuration settings for services, in many instances a user may be provided with configuration settings for a service which have worked for other users and which may likely work for this user as well. In this regard, embodiments of the system may dynamically grow and learn from the experiences of users of the system so as to enable future users of services to quickly configure services without requiring users to possess more than rudimentary technical knowledge of how to properly configure settings for the services.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving an indication of a service;
determining whether configuration settings for the indicated service are previously stored;
retrieving stored configuration settings for the indicated service if configuration settings for the indicated service are previously stored;
receiving suggested configuration settings for the indicated service if configuration settings for the indicated service are not previously stored;
verifying the stored or suggested configuration settings; and
storing verified configuration settings in association with the indicated service.

2. A method according to claim 1, further comprising:
receiving one or more user settings unique to a user; and
wherein verifying the configuration settings further comprises verifying the configuration settings in conjunction with the user settings.

3. A method according to claim 2, wherein storing verified configuration settings comprises storing the verified configuration settings, but not the user settings.

4. A method according to claim 1, wherein retrieving stored configuration settings for the indicated service comprises determining which of a plurality of previously stored configuration settings are most frequently stored for the indicated service and retrieving the most frequently stored configuration settings.

5. A method according to claim 1, further comprising sending the stored or the suggested configuration settings to a remote device.

6. A method according to claim 1, wherein retrieving stored configuration settings for the indicated service comprises retrieving stored configuration settings from a database server and wherein storing verified configuration settings in association with the indicated service comprises storing verified configuration settings in a database of the database server.

7. A method according to claim 1, wherein the indicated service is an indication of an e-mail account comprising an e-mail address.

8. A method according to claim 7, wherein verifying the stored or suggested configuration settings comprises accessing an e-mail server using the stored or suggested configuration settings.

9. A computer program product comprising at least one computer-readable storage medium having computer-readable program code portions stored therein, the computer-readable program code portions comprising:
a first executable portion for receiving an indication of a service;
a second executable portion for determining whether configuration settings for the indicated service are previously stored;
a third executable portion for retrieving stored configuration settings for the indicated service if configuration settings for the indicated service are previously stored;
a fourth executable portion for receiving suggested configuration settings for the indicated service if configuration settings for the indicated service are not previously stored;
a fifth executable portion for verifying the stored or suggested configuration settings; and
a sixth executable portion for storing verified configuration settings in association with the indicated service.

10. A computer program product according to claim 9, further comprising:
a seventh executable portion for receiving one or more user settings unique to a user; and wherein the fifth executable portion includes instructions for verifying the configuration settings in conjunction with the user settings.

11. A computer program product according to claim 10, wherein the sixth executable portion includes instructions for storing verified configuration settings, but not the user settings.

12. A computer program product according to claim 9, wherein the third executable portion includes instructions for determining which of a plurality of previously stored configuration settings are most frequently stored for the indicated service and retrieving the most frequently stored configuration settings.

13. A computer program product according to claim 9, further comprising a seventh executable portion for sending the stored or the suggested configuration settings to a remote device.

14. A computer program product according to claim 9, wherein the third executable portion includes instructions for retrieving stored configuration settings from a database server and wherein the sixth executable portion includes instructions for storing verified configuration settings in a database of the database server.

15. A computer program product according to claim 9, wherein the indicated service is an indication of an e-mail account comprising an e-mail address.

16. A computer program product according to claim 15, wherein the fifth executable portion includes instructions for verifying the stored or suggested configuration settings by accessing an e-mail server using the stored or suggested configuration settings.

17. An apparatus comprising a processor configured to:
receive an indication of a service;
determine whether configuration settings for the indicated service are previously stored;
retrieve stored configuration settings for the indicated service if configuration settings for the indicated service are previously stored;
receive suggested configuration settings for the indicated service if configuration settings for the indicated service are not previously stored;
verify the stored or suggested configuration settings; and
store verified configuration settings in association with the indicated service.

18. An apparatus according to claim 17, wherein the processor is further configured to:
receive one or more user settings unique to a user; and
verify the configuration settings in conjunction with the user settings.

19. An apparatus according to claim 18, wherein the processor is further configured to store verified configuration settings, but not the user settings.

20. An apparatus according to claim 17, wherein the processor is further configured to determine which of a plurality of previously stored configuration settings are most frequently stored for the indicated service and to retrieve the most frequently stored configuration settings.

21. An apparatus according to claim 17, wherein the processor is further configured to send the stored or the suggested configuration settings to a remote device.

22. An apparatus according to claim 17, wherein the processor is further configured to:
retrieve stored configuration settings for the indicated service by retrieving stored configuration settings from a database server; and
store verified configuration settings by storing the verified configuration settings in a database of the database server.

23. An apparatus according to claim 17, wherein the indicated service is an indication of an e-mail account comprising an e-mail address.

24. An apparatus according to claim 23 wherein the processor is further configured to verify the stored or suggested configuration settings by accessing an e-mail server using the stored or suggested configuration settings.

25. An apparatus comprising:
means for receiving an indication of a service;
means for determining whether configuration settings for the indicated service are previously stored;
means for retrieving stored configuration settings for the indicated service if configuration settings for the indicated service are previously stored;
means for receiving suggested configuration settings for the indicated service if configuration settings for the indicated service are not previously stored;
means for verifying the stored or suggested configuration settings; and
means for storing verified configuration settings in association with the indicated service.
